(19) United States
(12) Patent Application Publication
(10) Pub. No.: US 2026/0295918 A1
(43) Pub. Date: Oct. 1, 2026

(54) CASTING UNIT, UNIT FOR PRODUCING A FILM AS WELL AS METHOD FOR PRODUCING A FILM

(71) Applicant: BRÜCKNER MASCHINENBAU GmbH, Siegsdorf (DE)

(72) Inventors: Peter MAURER, Rohrdorf (DE); Anton EDFELDER, Unterwössen (DE); Matthias THALHAMMER, Bernau am Chiemsee (DE); Anthimos GIAPOULIS, Traunstein (DE)

(21) Appl. No.: 19/569,574

(22) Filed: Mar. 17, 2026

(30) Foreign Application Priority Data
Mar. 18, 2025 (DE) 102025110463.8

(51) Int. Cl. B29C 48/14; B29C 48/00; B29C 48/08; B29C 48/88; B29C 48/92; B29L 7/00

(52) U.S. Cl. CPC B29C 48/147; B29C 48/0018; B29C 48/08; B29C 48/914; B29C 48/92; B29C 2948/92019; B29C 2948/92085; B29C 2948/92514; B29L 2007/008

(57) ABSTRACT

A casting unit for a unit for producing a film including a slot die, a chill roll and an air nozzle apparatus. The chill roll includes at least a circumferential surface and is designed to rotate about an axis so that the circumferential surface moves in a direction of rotation, and the slot die is configured to generate a melt. The air nozzle apparatus is connected to the slot die so that the circumferential surface of the chill roll, the melt, the slot die and the air nozzle apparatus are delimited by an intermediate space, and the air nozzle apparatus is designed to generate an air flow that impinges on the circumferential surface along a line of action counter to the direction of rotation and generates negative pressure in the intermediate space.

### CROSS REFERENCE TO RELATED APPLICATION

This application claims priority to German Patent Application Number DE 10 2025 110 463.8, filed Mar. 18, 2025, the entire contents of which is hereby incorporated by reference.

### FIELD OF DISCLOSURE

The disclosure relates to a casting unit, a unit for producing a film as well as method for producing a film.

### BACKGROUND

In the production of thin plastic films, a film of a plastic melt is initially applied to a chill roll, on which it cools and hardens. Here, air bubbles can be trapped between the plastic melt and the chill roll, said air bubbles becoming part of the film and thus impairing the quality of the film.

To avoid such entrapped air between the plastic melt and the chill roll, it is known to arrange a hood, which extends to below the slot die, counter to the direction of rotation before application of the melt. Air is then extracted from this hood to create a vacuum, which as a result is to reduce entrapped air. U.S. Pat. No. 5,618,568 A shows, for example, such a solution.

In the case of this solution, it is problematic that in order to attain an appreciable effect, this needs to be positioned very close to the chill roll in order to be capable of generating a sufficiently large vacuum. This makes the set-up of the unit difficult and time-consuming, thereby reducing the economic benefit.

### SUMMARY

There is provided a casting unit, a unit as well as a method for producing a film in which entrapped air between the plastic melt and the chill roll is reduced in a simple manner.

There is provided a casting unit for a unit for producing a film comprising a slot die, a chill roll and an air nozzle apparatus. The chill roll has a circumferential surface and is designed to rotate about an axis so that the circumferential surface moves in a direction of rotation. The slot die is designed to generate a melt that contacts the circumferential surface at a line of application. The air nozzle apparatus is connected to the slot die so that an intermediate space is delimited by the circumferential surface of the chill roll, the melt, the slot die and the air nozzle apparatus, wherein the air nozzle apparatus is designed to generate an air flow that impinges on the circumferential surface along a line of action counter to the direction of rotation and generates negative pressure in the intermediate space.

As the negative pressure is generated by the air flow that contacts the circumferential surface of the chill roll, the intermediate space is closed along the width tightly, thereby making is possible to generate the negative pressure easily. In addition, exact positioning of larger components, such as a hood, is not necessary.

In particular, the negative pressure is present in the region below the melt and/or in the section of the intermediate space from the zero line in the direction of rotation.

Furthermore, the airflow contacting the circumferential surface detaches a boundary layer of air that moves with the circumferential surface from the circumferential surface. In this way, entrapped air in the melt can be reduced further.

Within the scope of this disclosure, the direction of rotation corresponds to a direction in the circumferential direction that is defined by the circumferential direction of the chill roll. Similarly, an axial direction can be defined by the axial direction of the chill roll.

In particular, the line of application and the line of action extend in the axial direction.

The air flow can also constitute a delimitation the intermediate space. The air flow particularly conveys air out of the intermediate space.

The casting unit can comprise an application device that is designed to apply the melt on the chill roll particularly uniformly and reliably. The application device can be what is termed a “pinning device,” for example an electrostatic application device (“e-pinning device”). Such application devices are known for example from DE 10 2022 118 971 A1. Other pinning devices can also be used.

In an embodiment, the slot die comprises an exit opening that is open towards the circumferential surface in the direction of rotation and/or the radial direction, thereby enabling the melt to be applied to the chill roll in a particularly controlled manner.

The direction of the opening, i.e. the direction normal to the opening, has for example, a component in the direction of rotation and a component in the radial direction towards the circumferential surface.

The exit opening can be offset to the zero line in the direction of rotation.

In an embodiment, the exit opening and/or the melt has a width in the axial direction and the width of the intermediate space, the air flow and/or the air nozzle apparatus in the axial direction is smaller than, equal to or greater than the width of the exit opening and/or the melt. In this way, it is ensured that entrapped air is avoided across the entire width of the melt.

The width of the chill roll equals or is greater than the width of the air nozzle apparatus, the air flow and/or the melt.

To avoid irregularities in the film, the exit opening, the melt, the intermediate space and/or the air flow can be continuous in the axial direction.

In an embodiment, the air nozzle apparatus comprises a flow guide section that defines a gap between the chill roll and the air nozzle apparatus, wherein the air flow flows through the gap, in particular wherein the gap is between 0 mm and 6 mm, in particular between 1.5 mm and 3.5 mm. The negative pressure in the intermediate space can be adjusted by means of the size of the gap.

The negative pressure in the intermediate space can be adjusted by the level of positive pressure that is provided by the compressed air source.

For example, the flow guide section is wedge-shaped, rounded and/or convex with a tip towards the chill roll. The flow guide section can be made of polyether ether ketone (PEEK).

The line of action is particularly in the gap, in front of the gap in relation to the direction of rotation or after the gap in relation to the direction of rotation.

In an embodiment, the air flow at the line of action and/or in the gap has a speed of between 50 m/s and 250 m/s, in particular between 50 m/s and 200 m/s, and/or the negative pressure in the intermediate space is between 500 Pa and 25,000 Pa, in particular between 5 Pa and 25,000 Pa, for example between 5 Pa and 600 Pa, in particular between 30 Pa and 150 Pa, or between 500 Pa and 20,000 Pa, thereby making it possible to reduce the entrapped air further.

The pressure data of the negative pressure is to be understood as the pressure difference to the ambient pressure.

For a particularly high quality of film produced, the line of application can be offset in the direction of rotation and/or the line of action can be offset to a zero line counter to the direction of rotation, in particular wherein the zero line corresponds to a radially extending straight line through the vertex of the chill roll in the properly assembled position.

The vertex is also termed the 12 o'clock position.

The spacing of the zero line to the melt and/or to the line of application can be between 30 mm and 100 mm, and the spacing between the zero line and the air flow and/or the line of action can be between 30 mm and 145 mm, each measured along the tangents at the zero line.

To remove the boundary layer particularly from the chill roll effectively, the air flow can contact the circumferential surface at an angle of incidence that is between 0° and 80°, in particular between 5° and 40°.

Within the scope of this disclosure, the angle of incidence is understood to mean the angle between the air flow and the tangent at the line of action.

The angle of incidence is particularly constant along the width of the air flow.

For a space-saving integration, the air nozzle apparatus can be attached to the slot die, in particular to the side of the slot die facing the chill roll.

The air nozzle apparatus can be designed moveably relative to the slot die in order to be capable of adjusting the position of the air flow and/or the gap to the circumstances, e.g. the material of the film to be produced.

In an embodiment, the air nozzle apparatus has a nozzle section comprising a nozzle opening that is open towards the line of action, the gap and/or the flow guide section, in particular wherein the air nozzle apparatus comprises at least one compressed air source that is designed to convey air to the nozzle opening in order to generate the air flow. In this way, the air flow exiting the nozzle opening can be generated in a controlled manner.

The compressed air source can be arranged on the end face of the air nozzle apparatus. It is conceivable that two comprised air sources are provided that are arranged, for example, on two opposing end faces of the air nozzle apparatus.

The compressed air source is, for example, at least a tube and/or hose, for example a tube and/or hose system. For example, this can be supplied with compressed air by means of a compressor that is part of the compressed air source. The compressor can be located in a space that separate from the unit.

In one aspect, the air nozzle apparatus comprises a reservoir from which the nozzle opening extends. Pressure that is uniform in the axial direction and thus a homogeneous air flow is generated by means of the reservoir.

In particular, the nozzle opening and/or the reservoir are the same width or wider than the width of the melt. The nozzle opening and/or the reservoir are, for example, continuous along the entire length.

The air nozzle apparatus, in particular the nozzle section, can comprise an inlet chamber and several ducts in order to keep the pressure constant in the reservoir in the axial direction, wherein the ducts connect the inlet chamber fluidly to the reservoir, in particular wherein said at least one compressed air source is arranged on an end face of the inlet chamber.

In particular, the inlet chamber is continuous along its width. The width of the inlet chamber can correspond to the width of the reservoir.

In an embodiment, the casting unit has a control device and the air nozzle apparatus has at least one compressed air source comprising a pressure regulating valve. The control device is connected to the pressure regulating valve and configured in such a way to control the pressure regulating valve. In this way, the negative pressure in the intermediate space can be automatically set precisely, in particular in order to prevent that the melt flaps before contacting the chill roll.

For example, the control device is configured to receive the speed of the chill roll as an input quantity and to output to the pressure regulating valve a control signal for the pressure regulating valve based on at least the speed of the chill roll.

In particular, the pressure regulating valve influences the level of the negative pressure in the inlet chamber and thus the pressure of the air flow and the negative pressure in the intermediate space.

It is also conceivable that the level of negative pressure in the inlet chamber and/or the input pressure is set manually. For example, the pressure regulating valve is a manually actuatable valve.

To increase the negative pressure in the intermediate space, the air nozzle apparatus can comprise two end-face covers, which are each arranged on one of the end faces of the intermediate space and close the intermediate space in the axial direction, in particular wherein at least one of the covers comprises a pressure sensor and/or a measuring opening that is fluidly connected to a pressure sensor.

The covers are moveable in the circumferential direction and the radial direction, for example, independent of the nozzle section of the air nozzle apparatus.

Moreover, there is further provided a unit for producing a film, comprising a casting unit as described previously and a stretching unit, in particular a transverse direction orienter, machine direction orienter and/or simultaneous stretching unit.

The features and advantages described for the casting unit apply equally to the unit and vice versa.

Further, there is provided a method for producing a film using a unit as described previously, wherein the melt is generated by means of a slot die and applied to the chill roll, wherein the negative pressure is generated in the intermediate space at the same time.

The features and advantages described for the casting unit and/or unit equally apply to the method and vice versa.

For example, the level of the negative pressure in the intermediate space is controlled by a control device of the casting unit, in particular based on at least the speed of the chill roll.

### BRIEF DESCRIPTION OF THE DRAWINGS

Additional features and advantages of the disclosure are found in the following description as well as the attached drawings to which reference is made.

FIG. 1 shows a schematic view of a unit according to an embodiment of the disclosure comprising a casting unit according to an embodiment of the disclosure.

FIG. 2 shows the casting unit according to FIG. 1 in a schematic perspective representation.

FIG. 3 shows a principle schematic view of the casting unit according to FIG. 2 in section.

FIG. 4 shows a flow diagram of an embodiment of a method according to the disclosure.

FIG. 5 shows a detailed side view of a casting unit of an embodiment of the disclosure.

FIG. 6 shows a sectional view of the air nozzle apparatus of the application device according to FIG. 5.

FIG. 7 shows an underside view of a section of the application device according to FIG. 5.

FIG. 8 shows an enlarged sectional view of the air nozzle apparatus of the application device according to FIG. 5 in the region of the air flow.

FIG. 9 shows a representation of the air pressure in the intermediate space.

FIG. 10 shows a graph with two exemplary curves representing the dependence of the desired value of the inlet pressure on the speed of the chill roll.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

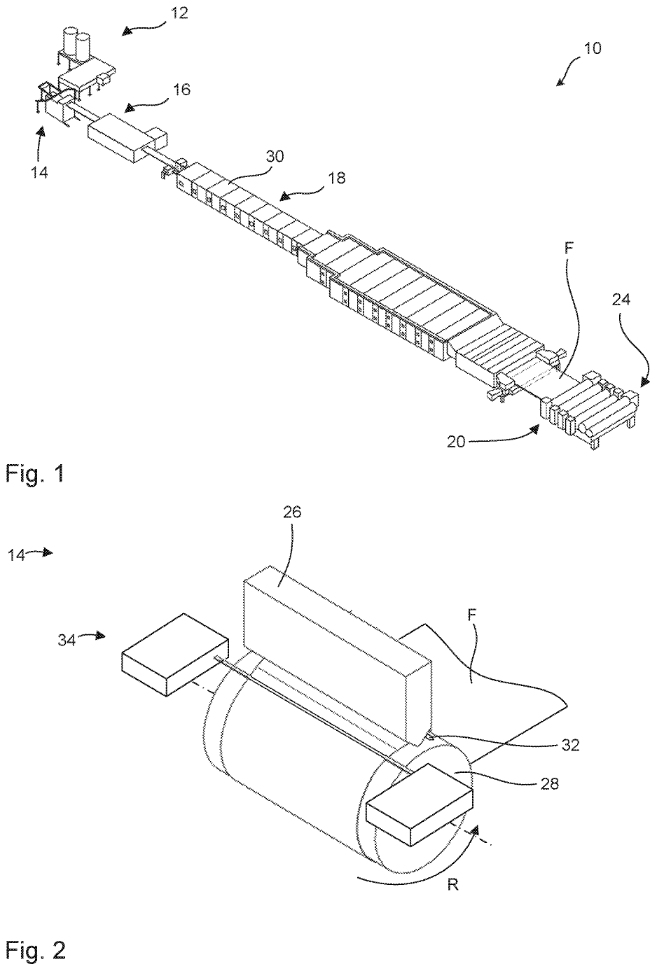

In FIG. 1, a unit 10 for producing a film F is shown extremely schematically, which comprises several different units and apparatuses.

For example, the unit 10 is a sequential film production unit, by means of which-without any limitation in the scope of the protection—the disclosure is explained exemplarily.

In the shown example, the unit 10 comprises an extrusion unit 12, a casting unit 14, at least a machine direction orienter 16 (MDO), a transverse direction orienter 19 (TDO), and treatment apparatus 20 as well as a winding apparatus 24.

The extrusion unit 12 comprises an extruder and is configured to generate a melt from at least one starting product. The melt is a plastic melt.

For example, the extruder is or the extruders are single-screw extruders, cascade extruders and/or twin-screw extruders.

It is also conceivable that other mixing and processing units are used, such as a Buss kneader (buskneter) or a planetary roller extruder.

Similarly, it is possible to generate the melt by means of polymerisation. To this end, the monomers (and optionally additives, such as catalysts) are mixed and polymerized in a reactor and/or an extruder of the extrusion unit 12.

The meld can be applied directly via a slot die 26 of the casting unit 14 onto a chill roll 28 of the casting unit 14, thereby generating the film F.

The chill roll 28 has, for example, a diameter of between 50 cm and 4 m.

The generated film F can comprise one or more layers. In the case of a multi-layer film, it is conceivable that an extruder generates several or all layers, or that an extruder is provided for each layer.

Subsequently, the film F is fed to the machine direction orienter 16 and stretched there in the machine direction.

The transverse direction orienter 18, as described for example in DE 10 2021 128 332 A1, has an oven 30 with different zones for temperature controlling the film along the usual direction of travel and drawing direction.

In the oven 30, the film F is heated in the known manner and stretched by the transverse direction orienter 18 in the transverse direction, thereby producing a monoaxially oriented film or, as in the embodiment, a biaxially orientated film.

The optional treatment apparatus 20 is, for example, an apparatus for activating the surface of the film F by means of a corona treatment, for example in order to realise better metal bonding. The corona treatment can occur on one side or both sides.

The winding apparatus 24 is used to wind the produced film F and is the last apparatus in the drawing direction. It comprises a winding core, on which the film F is wound.

In FIG. 2, the casting unit 14 (also termed the chill roll unit) is shown in an enlarged schematic view.

The casting unit 12 shown here comprises the slot die 26, the chill roll 28 as well as an air nozzle apparatus 32 and an optional application device 34.

The application device 34 can be what is termed a pinning device, for example an electrostatic application device (“e-pinning device”). Such application devices are known for example from DE 10 2022 118 971 A1. Other application devices 34 can also be used. The application device 34 is not shown in the remaining figures for the sake of clarity.

The chill roll 28 is cooled and is therefore termed “chill roll”. It has an axis that extends into the drawing plane and defines an axial direction, an external circumference that defines a circumferential direction, and a radius that defines a radial direction.

The chill roll 28 has a circumferential surface 36 over its circumference and is designed to rotate about an axis, thereby moving the circumferential surface 36 in the circumferential direction in a direction of rotation R.

To this end, a motor can be provided.

The slot die 26 is arranged above the chill roll 28 and is designed to apply the melt 38 forming the film F continuously to the chill roll 28. The plastic of the melt 38 is in particular a polyethylene terephthalate (PET). The use of other plastics is also conceivable.

In the axial direction, the chill roll 28 has width that is greater than the width of the melt 38.

The slot die 26 and the air nozzle apparatus 32 also have a width that is smaller than, the same as or greater than the melt 38, however less than the width or equal to the width of the chill roll 28.

In particular, the melt 38 is continuous in the axial direction, i.e. along its width, so that a continuous film F is generated.

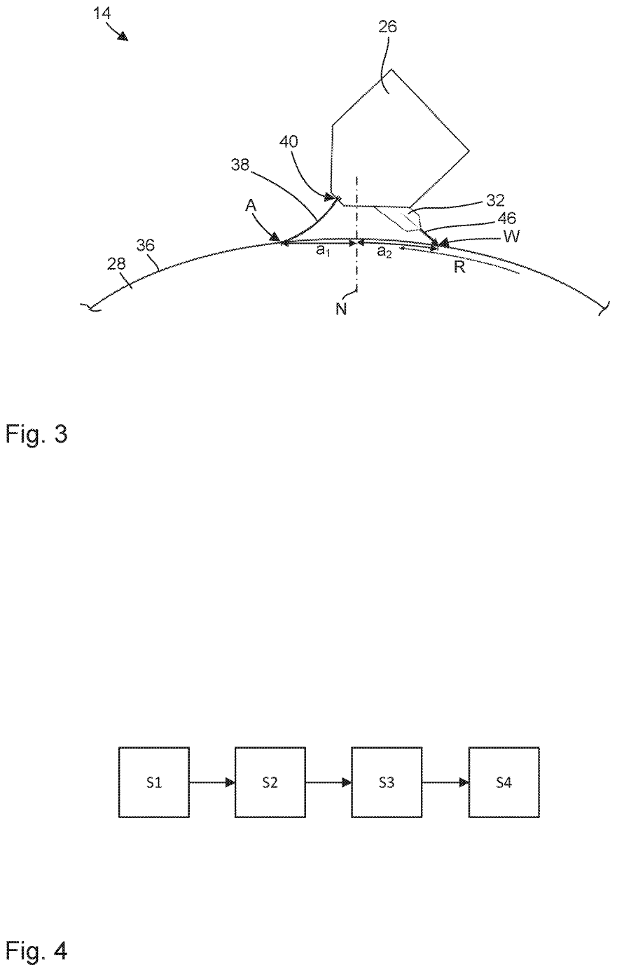

In FIG. 3, a sectional view through FIG. 2 is shown that is also greatly simplified like FIG. 2 in order to explain the principle.

The slot die 26 is arranged above the chill roll 28, for example above the upper vertex of the chill roll 28. The zero line N of the chill roll 28, i.e. a straight line extending radially through the upper vertex of the chill roll 28, thus intersects the slot die 26.

The slot die 26 is arranged radially spaced apart from the circumferential surface 36 of the chill roll 28 and has an exit opening 40 from which the melt 38 extrudes during operation.

The exit opening 40 is arranged in the direction of rotation R offset to the zero line N and, for example, as shown in the embodiment, is open in the direction of rotation R and in the radial direction towards the circumferential surface 36.

The direction of the exit opening 40 corresponds here to the direction normal to the opening. As seen in FIG. 3, this normal has a component in the direction of rotation R and a component in the radial direction towards the circumferential surface 36.

It is also conceivable that the exit opening 40 is solely open towards the circumferential surface 36.

In the axial direction, the exit opening 40 is continuous and its width corresponds to the width of the melt 38.

During operation, as shown in FIG. 3, the melt 38 exits the exit opening 40 and is deposited on the chill roll 28.

The line in the axial direction, on which the melt 38 contacts the chill roll 28, is referred to as the line of application A. The line of application A is offset from the exit opening 40 in the direction of rotation R, wherein the offset increases with increasing rotational speed v of the chill roll 28.

The line of application A and the melt 38 have a spacing a₁ to the zero line N. This can amount to between 30 mm and 100 mm. For example, this spacing a₁ is determined along a tangent of the circumferential surface 36 at the intersection with the zero line N. Accordingly, the line of application A is not exactly on this tangent, however only slightly offset to this as the diameter of the chill roll 28 is very large in comparison to the spacing a₁.

The air nozzle apparatus 32 is connected to the slot die 26. For example, as in the shown embodiment, the air nozzle apparatus 32 is attached to the slot die 26 on the side of the slot die 26 facing the chill roll 28.

The entire air nozzle apparatus 32 or the nozzle section 42 can be designed moveably relative to the slot die 26, in particular in the radial direction and the direction of rotation R.

The air nozzle apparatus 32 has a nozzle section 42, as shown in FIG. 3, which has a nozzle opening 44.

The nozzle opening 44 is used to generate an air flow 46, as will be described in detail.

The nozzle opening 44 and the air flow 46 are designed continuously in the axial direction, i.e. along the width. In addition, the width of the air flow 46 and/or the nozzle opening 44 can be narrower than, equal to or wider than the melt 38.

The nozzle opening 44 is open counter the direction of rotation R and also has a component in the radial direction inwards towards the circumferential surface 36. The air flow 46 generated flows counter to the direction of rotation R and towards the circumferential surface 36 and impinges on the circumferential surface 36 along a line of action W. The line of action W extends accordingly in the axial direction.

Starting from the zero line N, the line of action W and the air flow 46 are offset by a spacing a₂ counter to the direction of rotation R. The spacing a₂ is, for example, between 30 mm and 145 mm. Also here, the line of action is not exactly on the tangent.

The air nozzle apparatus 32 is also radially spaced apart from the circumferential surface 36.

As can be seen in FIG. 3, an intermediate space 48 is formed during operation that is delimited downwards, thus radially inwards, by the circumferential surface 36 of the chill roll 28, is delimited in the direction of rotation R by the melt 38, and is delimited upwards by the slot die 26 and in part the air nozzle apparatus 32 as well as is delimited counter to the direction of rotation R by the air nozzle apparatus 32.

The intermediate space 48 is thus mainly separated from the environment so that other air pressure ratios can be formed in the intermediate space as in the environment.

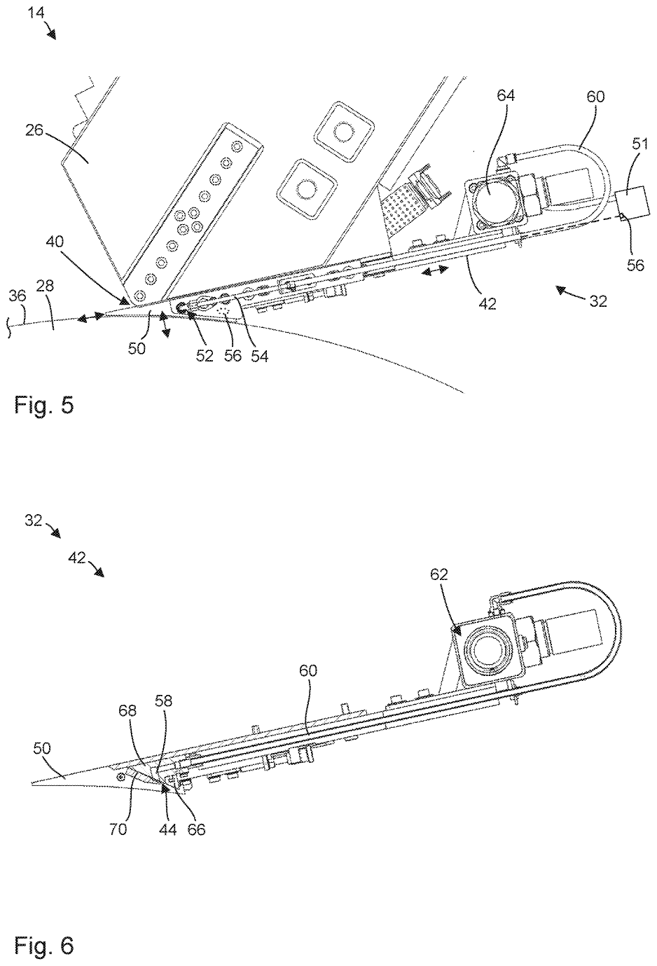

The intermediate space 48 also extends in the axial direction and is continuous in the axial direction. The intermediate space 48 can be closed on the end faces in the axial direction by covers 50 (FIG. 5) of the air nozzle apparatus 32.

The width of the intermediate space 48 is thus equal to or larger than the width of the melt 38 and/or the exit opening 40.

It is also conceivable that the width of the intermediate space 48 is smaller than the width of the melt 38 and/or the exit opening 40. In this way, the necessary negative pressure can also be generated if the mass flow rate of the air nozzle apparatus 32 is increased.

During operation, the air flow 46 is generated. The air flow 46 is directed counter to the direction of rotation R, i.e. out of the intermediate space 48, and thus takes air out of the intermediate space 48. Owing to the Bernoulli effect, negative pressure thus develops in the intermediate space 48.

The air flow 46 can be regarded as a further delimitation of the intermediate space 48.

For example, the negative pressure, i.e. the pressure difference to the ambient pressure, can be between 500 Pa and 25.000 Pa, in particular between 500 Pa and 20.000 Pa.

This negative pressure, for example at this level, occurs in particular in the region below the melt 38, i.e. between the melt 38 and the circumferential surface 36, and/or in a region of the intermediate space 48 from the zero line N in the direction of rotation R towards the melt 38. For example, the negative pressure occurs from the melt 38 to the gap 74.

As a result of this negative pressure below the melt 38, entrapped air is considerably reduced between the melt 38 and the chill roll 28.

In addition, the air flow 46 also reduces potential entrapped air in another way. During operation of the unit 10, the chill roll 28 rotates, thereby taking air from the environment along the circumferential surface 36. A boundary layer made of air thus forms along the circumferential surface 36, said boundary layer moving in the direction of rotation R.

The air flow 46 contacts the circumferential surface 36 counter to the direction of rotation R, which as a result detaches the boundary layer from the circumferential surface 36 and thus cannot enter the intermediate space 48 and come between the melt 38 and the circumferential surface 36. During operation of the unit 10, as the method for producing the film F, as shown simplified in FIG. 4, the melt 38 is generated by means of the slot die 26 (S1) and applied to the chill roll 28 (S2). At the same time, negative pressure is generated in the intermediate space (S3). The film F applied to the chill roll 28 is subsequently finished directly (S4), for example in the machine direction orienter 16 and then in the transverse direction orienter 18.

In FIGS. 5 to 8, an embodiment of the casting unit 14 is shown in a greater level of detail. The additional features and advantages of the casting unit 14 described in connection to these figures are not limited however to this embodiment but can also be easily transferred individually to other casting units 14, as described in general above with regard to the figures.

FIG. 5 shows a side view of the casting unit 14 in the region of the vertex of the chill roll 28.

In addition to the nozzle section 42, the air nozzle apparatus 32 also comprises a cover 50 that delimits the intermediate space 48 on the end face and thus obstructs the view into the intermediate space 48 in the representation of FIG. 5.

In addition to the cover 50, the air nozzle apparatus 32 comprises a control device 51 that is provided, for example as in the shown embodiment, spatially separated from the slot die 26.

The intermediate space 48 is also closed by another one of these covers 50 on the axially opposing end face.

The covers 50 are moveable independent of the nozzle section 42 in the circumferential direction and in the radial direction, as illustrated by the arrow on the cover 50 in FIG. 5.

The position of the covers 50 is selected here in such a way that they are positioned at a spacing to the circumferential surface 36 that is as small as possible. It is also conceivable that the exit opening 50 contacts the circumferential surface 36.

The covers 50 are located, for example, in the axial direction outside the region in which the melt 38 is applied to the chill roll 28.

The covers 50 have a contour that correspond to the contour of the intermediate space 48, in particular at the maximum rotational speed v of the chill roll 28, or a contour that is larger than this maximum contour.

For example, at least one of the covers 50 has a measuring opening 52 that extends through the cover 50. On the external side, a tube 54 that closes the measuring opening 52 is provided on the cover. The other end of the tube 54 is connected to a pressure sensor 56 of the control device 51.

The tube 54 is only shown in part in the figures.

In this way, the pressure can be determined by the control device 51 in the intermediate space 48.

It is also conceivable that a hose or a combination of tube 54 and hose are used instead of the tube 54.

It is also conceivable that the pressure sensor 56 is provided directly in the measuring opening 52 or on the cover 50 within the intermediate space 48.

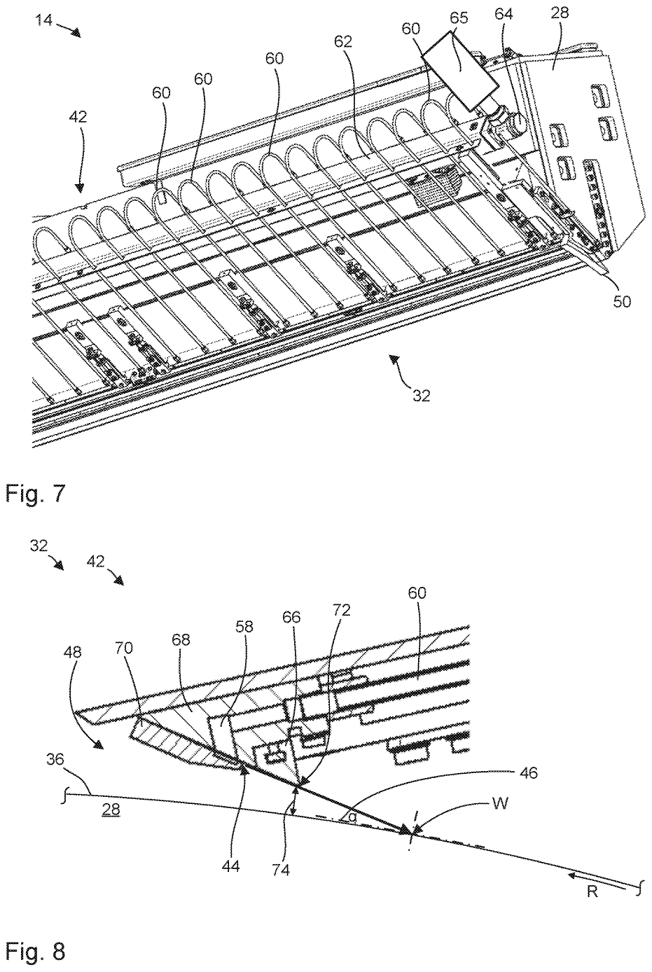

In FIG. 6, the air nozzle apparatus 32 is shown, more specifically the nozzle section 42 and the back of the covers 50. The nozzle section 42 is shown in section. FIG. 7 shows the air nozzle apparatus 32, in particular the nozzle section 42, in an underside view.

In addition of the nozzle opening 44, the nozzle section 42 comprises a reservoir 58, several ducts 60, an inlet chamber 62 as well as compressed air source 64. The inlet chamber 62 is a cavity that extends in the axial direction, in particular is continuous in the axial direction.

One or two compressed air sources 64 are arranged on one or both of the end faces of the inlet chamber 62, said compressed air sources 64 conveying air from the environment into the inlet chamber 62 and thus generating a positive pressure in the inlet chamber 62. The compressed air source(s) can be controlled, for example, by the control device 51.

The compressed air source 64 is, for example, a tube and/or hose that is supplied with compressed air from a compressor. The tube and/or hose can be part of a tube system and/or hose system. The compressor can be located in one of the spaces separate from the unit and can be controlled by the control device 51.

For example, the compressed air source 64 comprises a pressure regulating valve 65 that controls the input pressure p, i.e. the pressure of the air that is supplied to the inlet chamber 62.

The pressure regulating valve 65 is connected to the control device 51 and is controlled by the control device 51.

In addition, air filters can be provided on the end faces of the inlet chamber 62 or the compressed air sources 64 comprises air filters in order to prevent solids entering the intermediate space 48 which could impair the quality of the film.

Starting from the inlet chamber 62, the ducts 60 extend, for example, to the reservoir 58 in the form of tubes or hoses.

The ducts 60 are provided arranged spaced apart in the axial direction and along the entire width of the inlet chamber 62. The spacings are mostly regular.

For example, the air nozzle apparatus 32 comprises between 15 and 25 of the ducts 60.

The ducts 60 all open into the reservoir 58.

The reservoir 58 is a cavity that extends in the axial direction and can be continuous in the axial direction.

The reservoir 58 is closed on the end faces.

The nozzle opening 44 opens out of the reservoir 58. The reservoir 58 extends over the entire width of the nozzle opening 44 so that the reservoir 58 has a width that is wider than or the same width as the air flow 46 and thus the melt 38.

The ducts 60 open in the axial direction at regular intervals into the reservoir 58 in order to achieve a pressure distribution within the reservoir 58 that is homogeneous as possible.

The nozzle opening 44 is designed, for example as in FIG. 8, as a slot that is the only opening of the reservoir 58 except for the ducts 60.

For example, as in the shown embodiment, the nozzle opening 44 is designed as a slot between a first component 68 and a second component 70 of the nozzle section 42, wherein the reservoir 58 is designed in at least one, in particular both components 68, 70.

Accordingly, the nozzle opening 44 is in alignment with the surface of the first component 68.

The flow guide section 66 is designed in the surface of the first component 68.

For example, the flow guide section 66 is a component separate from the first component 68 that is attached to the first component 68. The flow guide section 66 can be made of PEEK.

For example, the flow guide section 66 is a wedge-shaped component in section comprising a tip towards the chill roll 28.

The flow guide section 66 can also be rounded and/or convex.

It is also conceivable that the flow guide section 66 is designed as a single piece together with the first component 68.

The flow guide section 66 has an edge 72 in the axial direction that is formed by the tip. The edge 72 is arranged spaced apart from the circumferential surface 36, wherein the edge 72 constitutes the point of the nozzle section 42 that is closest to the circumferential surface 36 of the chill roll 28.

The spacing between the edge 72 and the circumferential surface 36 thus constitutes a gap 74 between the chill roll 28 and the air nozzle apparatus 32 that forms an opening of the intermediate space 48 towards the environment.

The gap 74 is, for example, in the radial direction between 0 mm and 6 mm, in particular between 1.5 mm and 3.5 mm in size.

The flow guide section 66 and thus also the gap 74 have at least a width in the axial direction that corresponds to the width of the nozzle opening 44.

During operation of the air nozzle apparatus 32, positive pressure is generated in the inlet chamber 62 by the compressed air source 64. Accordingly, due to the fluid connection through the ducts 60, positive pressure also builds up in the reservoir 58, thereby generating the air flow 46 out of the nozzle opening 44.

The pressure of the air flow 46 can be set by the level of positive pressure in the inlet chamber 62.

As can be seen clearly in FIG. 8, the air flow 46 flows counter to the direction of rotation R along the first component 68 and the flow guide section 66. The air flow 46 flows then through the gap 74 and subsequently contacts the circumferential surface 36 of the chill roll 28 at the line of action W.

Accordingly, the line of action W in relation to the direction of rotation R is located before the gap 74. It is also conceivable that the line of action W is located behind the gap 74 or within the gap 74.

The air flow 46 can have speeds of between 50 m/s and 250 m/s, in particular between 50 m/s and 200 m/s, at the line of action W and/or in the gap 74. As a result, as already described, negative pressure between 5 Pa and 25,000 Pa, for example between 500 Pa and 25,000 Pa, in particular between 500 Pa and 20,000 Pa, can be achieved in the intermediate space 48. For example, negative pressure is generated between 5 Pa and 600 Pa, in particular between 30 Pa and 150 Pa.

At the line of action W, the air flow 46 contacts the circumferential surface 36 at an angle of incidence a between 0° and 80°, in particular between 5° and 40°.

The angle of incidence a is understood to mean here, for example, the angle between the air flow 46 and the tangent (shown with dotted lines) of the circumferential surface 36 at the line of action W.

The angle of incidence a is, for example, constant along the axial direction.

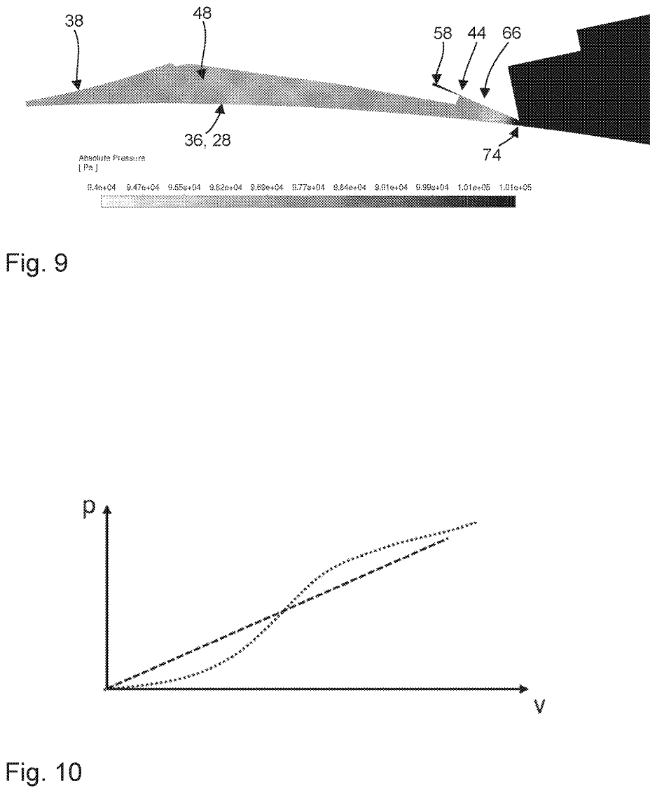

FIG. 9 shows a representation in a sectional view of the air pressure levels in the intermediate space 48, in parts of the reservoir 58 and in front of the gap 74 during operation of the unit 10. The components of the casting unit 14 as well as the unit 10 and the melt 38 are not shown. Their positions are however identified with the corresponding reference signs for the ease of reference.

It can be clearly seen that the air pressure in the intermediate space 48 is considerably lower than before the gap 74, thus forms a negative pressure in the intermediate space 48. In addition, the negative pressure in the intermediate space 48 is mostly homogeneous.

The control device 51 can be used for automatically controlling the casting unit 14.

The control device 51 controls the pressure regulating valve 65, thereby setting the level of the positive pressure in the inlet chamber 62 and thus the pressure of the air flow 46, which in turn influences the level of negative pressure in the intermediate space 48.

For example, the control device 51 receives the speed v of the chill roll 28 as the only input quantity or as one of the input quantities. This can be the desired speed and/or actual speed of the chill roll 28.

Using the speed v of the chill roll 28, the control device 51 establishes a control signal for the pressure regulating valve 65 that indicates, for example, a desired value for the input pressure p and/or the negative pressure in the intermediate space 48. It is also conceivable that the control signal indicates the desired opening width of the pressure regulating valve 65.

The control device 51 outputs the control signal to the pressure regulating valve 65 which receives the control signal and adjusts its opening width according to the control signal.

The actual value of the input pressure p can be determined, for example, by means of the pressure sensor 56 and also be used as the input quantity for the control device 51.

For example, a dependence of the desired value of the input pressure p on the speed v of the chill roll 28 is stored in the control device 51. This dependence can occur as a look-up table and/or a function.

An example of such a look-up table is reproduced in the following:

| speed v of the | negative pressure in the |
|---|---|
| chill roll 28 | intermediate space 48 |
| [m/min] | [Pa] |
| 10 | 37 |
| 20 | 40 |
| 40 | 45 |
| 60 | 51 |
| 80 | 56 |
| 100 | 62 |
| 120 | 67 |
| 140 | 73 |
| 160 | 78 |
| 180 | 84 |

FIG. 10 shows a graph comprising two exemplary curves that show the dependence of the desired value of the input pressure p on the speed v of the chill roll 28. The dashed line shows a linear dependence, and the dotted line a non-linear dependence, here in the form of an S curve.

It is also conceivable that the desired value of the input pressure p is dependent on more than one input quantity. Conceivable input quantities alone or in combination are as follows: the speed v of the chill roll 28, the production rate of the film F of the casting unit 14 and/or the unit 10 for producing a film F, the thickness of the film F, the material of the film F, and/or the temperature of the film F.

It is conceivable that the pressure regulating valve 65 is a manual valve and/or is actuatable manually. The input pressure, the level of the positive pressure in the inlet chamber 62 and thus the pressure of the air flow 46, which in turn influences the level of negative pressure in the intermediate space 48, can thus also be adjusted manually. By manually adjusting the input pressure, it is also possible to dispense with a control device.

1. A casting unit for a unit for producing a film, comprising:
a slot die;
a chill roll;
an air nozzle apparatus;
wherein the chill roll comprises a circumferential surface and configured to rotate about an axis so that the circumferential surface moves in a direction of rotation;
wherein the slot die is configured to generate a melt that contacts the circumferential surface at a line of application;
wherein the air nozzle apparatus is connected to the slot die so that an intermediate space is delimited by the circumferential surface of the chill roll, the melt, the slot die, and the air nozzle apparatus; and,
wherein the air nozzle apparatus is configured to generate an air flow that impinge on the circumferential surface along a line of action counter to the direction of rotation and generates negative pressure in the intermediate space.

2. The casting unit according to claim 1, wherein the slot die comprises an exit opening that is open at least one of in the direction of rotation or in the radial direction towards the circumferential surface.

3. The casting unit according to claim 1, wherein at least one of the exit opening or the melt have a width in the axial direction and the width of the intermediate space, at least one of the air flow or the air nozzle apparatus in the axial direction is smaller than, equal to or greater than the width of the at least one of exit opening or melt.

4. The casting unit according to claim 1, wherein at least one of the exit opening, the melt, the intermediate space or the air flow are continuous in the axial direction.

5. The casting unit according to claim 1, wherein the air nozzle apparatus comprises a flow guide section that defines a gap between the chill roll and the air nozzle apparatus, wherein the air flow flows through the gap.

6. The casting unit according to claim 5, wherein the gap is at least one of between 0 mm and 6 mm.

7. The casting unit according to claim 1, wherein the air flow at the line of action or in the gap has a speed of between 50 m/s and 250 m/s.

8. The casting unit according to claim 1, wherein the negative pressure in the intermediate space is between 5 Pa and 25,000 Pa.

9. The casting unit according to claim 1, wherein the line of application is offset in the direction of rotation, or the line of action is offset from a zero line counter to the direction of rotation.

10. The casting unit according to claim 1, wherein the air flow contacts the circumferential surface at an angle of incidence, wherein the angle of incidence is at least one of between 0° and 80°.

11. The casting unit according to claim 1, wherein the air nozzle apparatus is attached to the slot die, the air nozzle apparatus is designed moveably relative to the slot die.

12. The casting unit according to claim 1, wherein the air nozzle apparatus comprises a nozzle section comprising a nozzle opening that is open towards at least one of the line of action, the gap or the flow guide section.

13. The casting unit according to claim 12, wherein the air nozzle apparatus comprises at least one compressed air source that is designed to convey air to the nozzle opening in order to generate the air flow.

14. The casting unit according to claim 12, wherein the air nozzle apparatus comprises a reservoir from which the nozzle opening extends.

15. The casting unit according to claim 1, wherein the casting unit comprises a control device, and wherein the air nozzle apparatus comprises at least one compressed air source comprising a pressure regulating valve,
wherein the control device is connected to the pressure regulating valve and is configured to control the pressure regulating valve.

16. The casting unit according to claim 15, wherein the control device is configured to receive the speed of the chill roll as the input quantity and to output to the pressure regulating valve a control signal for the pressure regulating valve based on at least the speed of the chill roll.

17. The casting unit according to claim 1, wherein the air nozzle apparatus comprises two end-face covers, which are each arranged on one of the end faces of the intermediate space and close the intermediate space in the axial direction, wherein at least one of the covers comprises at least one of a pressure sensor or a measuring opening that is fluidly connected to a pressure sensor.

18. A unit for producing a film, comprising:
a casting unit;
a stretching unit;
wherein the casting unit comprises a slot die, a chill roll and an air nozzle apparatus;
wherein the chill roll comprises a circumferential surface and is designed to rotate about an axis so that the circumferential surface moves in a direction of rotation;
wherein the slot die is configured to generate a melt that contacts the circumferential surface at a line of application,
wherein the air nozzle apparatus is connected to the slot die so that an intermediate space is delimited by the circumferential surface of the chill roll, the melt, the slot die and the air nozzle apparatus; and,
wherein the air nozzle apparatus is designed to generate an air flow that impinge on the circumferential surface along a line of action counter to the direction of rotation and generates negative pressure in the intermediate space.

19. A method for producing a film by means of the unit according to claim 18, comprising generating a melt by a slot die and applied to the chill roll, and generating a negative pressure at the same time in the intermediate space.

20. The method according to claim 19, further comprising controlling the level of negative pressure in the intermediate space by a control device of the casting unit, or by a control device of the casting unit on the basis of at least the speed of the chill roll.
